(19) United States
(12) Patent Application Publication
(10) Pub. No.: US 2025/0103197 A1
(43) Pub. Date: Mar. 27, 2025

(54) USER INTERFACE CONTROL USING DELTA HEAD MOVEMENTS

(71) Applicant: GOOGLE LLC, Mountain View, CA (US)

(72) Inventors: Nooshin Mojab, New York, NY (US); Dongeek Shin, San Jose, CA (US); Andrea Colaco, Los Altos, CA (US)

(21) Appl. No.: 18/472,071

(22) Filed: Sep. 21, 2023

(51) Int. Cl. G06F 3/04845; G02B 27/01; G06F 3/01; G06F 3/0482

(52) U.S. Cl. CPC G06F 3/04845; G02B 27/0172; G06F 3/017; G06F 3/0482; G02B 2027/0141; G02B 2027/0178

(57) ABSTRACT

At least one sensor signal may be received from at least one motion sensor of a head-mounted device (HMD), the HMD being associated with a user interface (UI) displaying a UI selection element. A first value of the at least one sensor signal corresponding to a first position of the HMD and a second value of the at least one sensor signal corresponding to a second position of the HMD may be determined, and an initialization point within the UI may also be determined. Then, a relative displacement of the UI selection element may be determined, based on the initialization point, the first value, and the second value, and the UI selection element may be moved within the UI, based on the relative displacement.

### TECHNICAL FIELD

This description relates to input/output (I/O) techniques for wearable devices.

### BACKGROUND

Wearable devices, such as head-mounted devices (HMDs), provide various types of I/O techniques that differ from traditional keyboard and mouse techniques, and that utilize features of the wearable devices themselves. For example, HMDs may leverage built-in cameras to track an eye gaze of a user/wearer, then use the results of such eye gaze tracking as an I/O mechanism to enable, e.g., user interface (UI) icon selection, or other interactions between the user and the HMD.

### SUMMARY

In a general aspect, a non-transitory computer-readable medium may store executable instructions that when executed by at least one processor cause the at least one processor to receive at least one sensor signal from at least one motion sensor of a head-mounted device (HMD), the HMD associated with a user interface (UI) displaying a UI selection element, determine a first value of the at least one sensor signal corresponding to a first position of the HMD, and determine a second value of the at least one sensor signal corresponding to a second position of the HMD. When executed, the instructions may cause the at least one processor to determine an initialization point within the UI, determine a relative displacement of the UI selection element, based on the initialization point, the first value, and the second value, and move the UI selection element within the UI, based on the relative displacement.

In another general aspect, a head mounted device (HMD) includes at least one frame, at least one display displaying a user interface (UI) having a UI selection element, at least one motion sensor, at least one processor, and at least one memory, the at least one memory storing a set of instructions. When executed, the instructions cause the at least one processor to receive at least one sensor signal from the at least one motion sensor, determine a first value of the at least one sensor signal corresponding to a first position of the HMD, and determine a second value of the at least one sensor signal corresponding to a second position of the HMD. When executed, the instructions cause the at least one processor to determine an initialization point within the UI, determine a relative displacement of the UI selection element, based on the initialization point, the first value, and the second value, and move the UI selection element within the UI, based on the relative displacement.

In another general aspect, a method includes receiving at least one sensor signal from at least one motion sensor of a head-mounted device (HMD), the HMD associated with a user interface (UI) displaying a UI selection element. The method includes determining a first value of the at least one sensor signal corresponding to a first position of the HMD, determining a second value of the at least one sensor signal corresponding to a second position of the HMD, and determining an initialization point within the UI. The method includes determining a relative displacement of the UI selection element, based on the initialization point, the first value, and the second value, and moving the UI selection element within the UI, based on the relative displacement.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for user interface control using delta head movements.

FIG. 2 is a flowchart illustrating example operations of the system of FIG. 1.

FIG. 3 is a block diagram of an example system that may be used in the system of FIG. 1.

FIG. 4 illustrates example pre-processing techniques that may be used in the example of FIG. 3.

FIG. 5A illustrates graphs showing example training data used in the example of FIG. 3.

FIG. 5B illustrates graphs showing example test results data of the example of FIG. 3.

FIG. 5C illustrates graphs showing example training data for a first example machine learning model.

FIG. 5D illustrates graphs showing example test data for the example machine learning model of FIG. 5C.

FIG. 5E illustrates graphs showing example training data for a second example machine learning model.

FIG. 5F illustrates graphs showing example test data for the example machine learning model of FIG. 5E.

FIG. 6 is a flowchart illustrating example operations of the systems of FIGS. 1 and 3.

FIG. 7 is a third person view of a user in an ambient computing environment.

FIGS. 8A and 8B illustrate front and rear views of an example implementation of a pair of smartglasses.

### DETAILED DESCRIPTION

Described systems and techniques enable UI control based on head movements of a user, as detected by a HMD being worn by the user. Delta or differential movements of a UI control element within a corresponding UI may be determined by processing sensor signals from motion sensors of the HMD. As a result, for example, a relative displacement of the UI control element may be determined, so that a UI control may be enabled or enhanced in a reliable, accurate, inexpensive manner. Moreover, such head-based UI control may be provided without requiring excessive levels of head movement on the part of the user, and without requiring calibration with a global coordinate system of the UI(s).

For example, a user may utilize a HMD to interact with any type of 2D or 3D user interface, including many different types of UI control elements. As referenced above, existing techniques for UI control using a HMD include eye gaze tracking techniques that rely on cameras of a HMD. Although potentially useful in many scenarios, such techniques may be costly with respect to camera requirements, and may require excessive levels of battery/power.

As described herein, UI control may be provided using head tracking results determined from one or more motion sensors of the HMD. Conventional head tracking techniques have often required supplemental or coordinated eye gaze tracking for desired levels of accuracy. Moreover, both gaze and/or head tracking systems may require definition and knowledge of a global coordinate system that is defined with respect to a UI being controlled. For example, an eye or head gaze may be determined and matched to a corresponding coordinate(s) of a UI. As a result, such tracking systems typically require calibration across multiple UIs, even for a single user, and cannot practically be made applicable across many different types of UIs.

Additionally, such approaches may suffer from requiring a user to provide undesirable or excessive head movements in order to obtain a desired type or degree of UI control. Further, such conventional approaches have been unable to sufficiently discern head movements intended for UI control from various other types of head movements, such as head movements associated with walking.

Described techniques, as referenced above and described in detail, below, use tracked head movements to determine a relative displacement of a UI control element within the context of a corresponding UI, without requiring correlation of a tracked head position/gaze and a corresponding UI coordinate(s) within a fixed or known coordinate system. Instead, relative displacement of the UI control element is recursively determined relative to an initialization point, which may be easily defined with respect to many or all UIs.

Described techniques may be adjusted as needed to provide desired levels of sensitivity between a user's head movements and corresponding movements of a UI control element being controlled. For example, described techniques may relate a baseline variance in a user's head movements to relative proportions of UI elements (such as by enlarging distances between UI elements for users with relatively large degrees of variance), to thereby facilitate user ease and accuracy in making UI element selections. Additionally, described techniques are capable of discerning head movements intended for UI control from other head movements that may be detected. Consequently, users may be provided with a UI control system that is widely applicable across many different types of UIs and many different types of HMDs, while being customizable with respect to users' preferences and needs.

Still further, described techniques enable predictive UI control to enhance a user's experience of the UI being controlled. For example, a stability of a user's head gaze/direction may be used to infer or predict the user's intention to make a selection of a particular UI element. Then, prior to the selection being made, described techniques may pre-render or otherwise prepare corresponding selection results. Therefore, the user will experience reduced/minimal latency between making the selection and receiving the selection results.

Somewhat similarly, described techniques may determine a speed or acceleration of movement of a UI control element being moved, and may project or estimate corresponding future movements based thereon. Such projected/estimated future movements may thus be used to predict likely UI locations or elements that may be viewed, accessed, or selected, so that corresponding calculations or other operations may be made in advance, and again a latency experienced by users may be reduced or minimized.

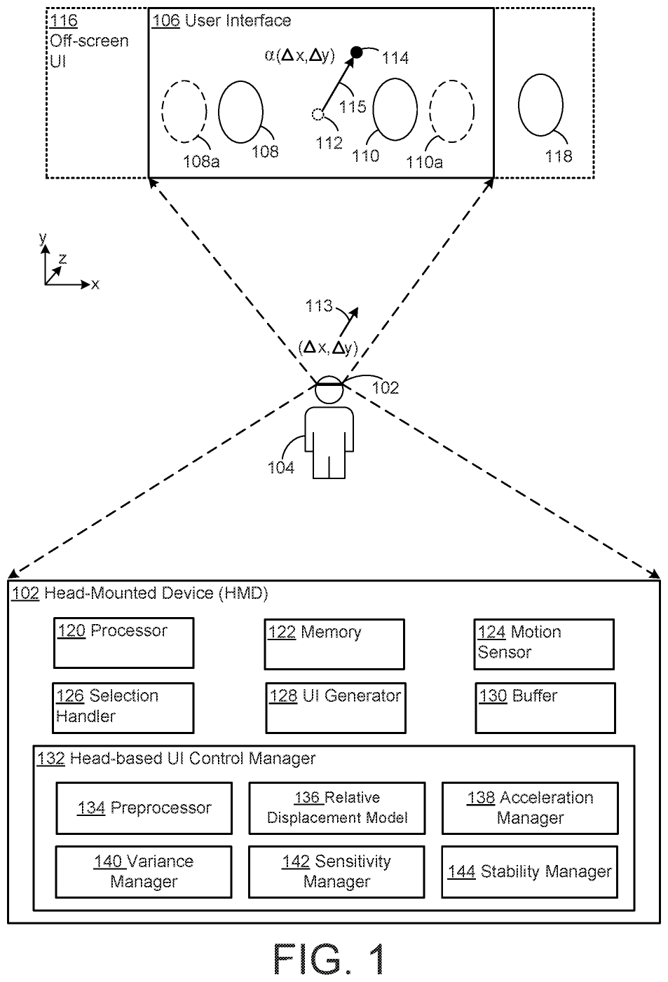

FIG. 1 is a block diagram of a system for user interface control using delta head movements. In the example of FIG. 1, a HMD 102 is illustrated as being worn by a user 104. The HMD 102 is illustrated as generating, or otherwise being associated with, a user interface (UI) 106. For the sake of the simplified example of FIG. 1, the UI 106 is illustrated as including a UI element 108 and a UI element 110.

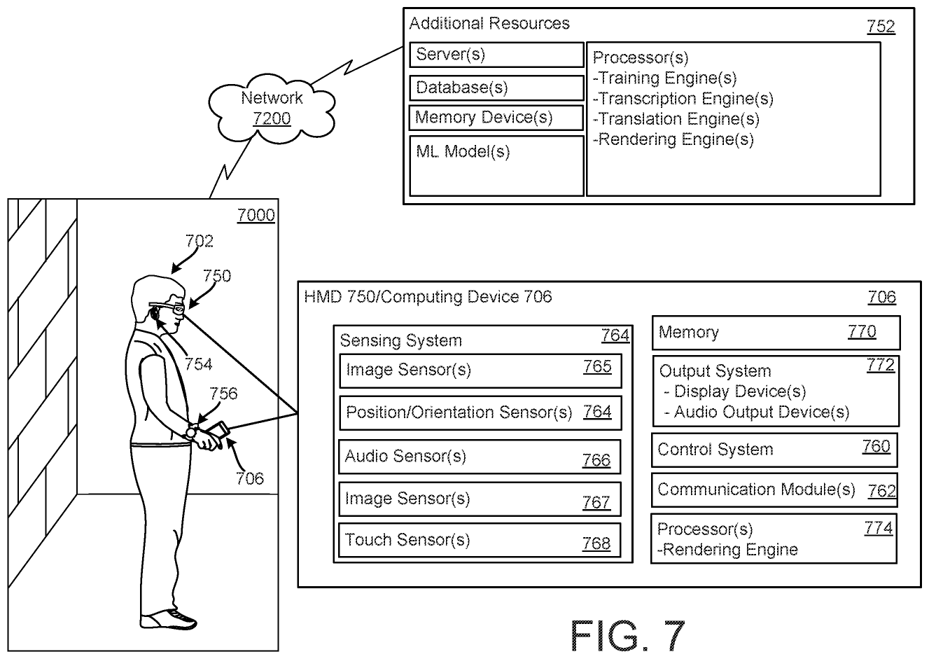

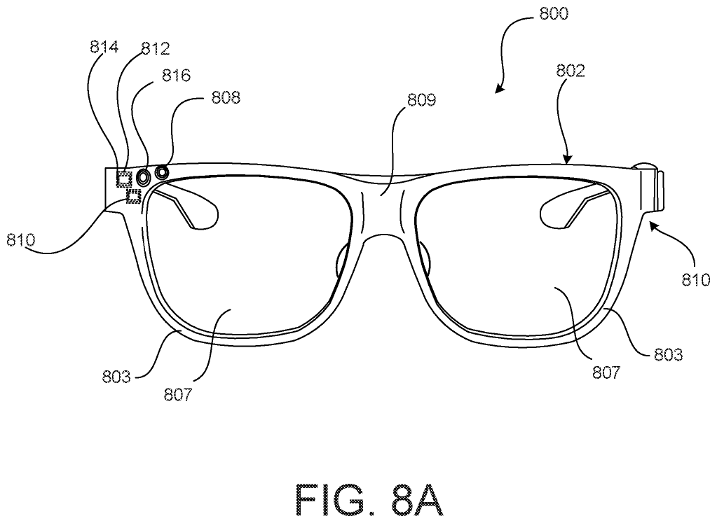

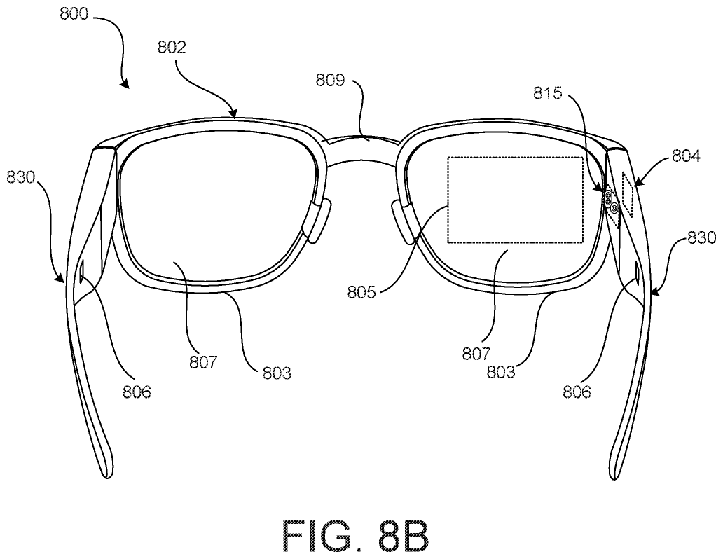

The HMD 102 should be understood to represent any device that may be worn on a head of the user 104, and that may be configured to provide the resources and features illustrated in the exploded view of FIG. 1 (which are described in more detail, below). Various examples of the HMD 102 are illustrated and described, e.g., with respect to FIG. 7 and FIGS. 8A and 8B, including smartglasses, goggles, or earbuds.

The UI 106 should thus be understood to represent any UI that is controllable by, e.g., in communication with, the HMD 102. For example, in many of the following examples, the UI 106 is described as a UI that is projected and otherwise rendered by the HMD 102 itself, such as when the UI is shown on a display of the smartglasses of FIGS. 8A and 8B. In other examples, however, the UI 106 may be generated by a separate device, such as a smartphone, or using a stand-alone monitor or display.

Accordingly, the UI 106 should be understood to represent any 2D or 3D UI with which the user 104 may interact. That is, in addition to 2D examples that may occur with respect to a smartphone or stand-alone monitor, the UI 106 may provide a panoramic or 3D view. In some examples, an immersive 3D experience may be provided, e.g., through the use of smartglasses or googles.

Therefore, the UI element 108 and the UI element 110 should be understood to represent any control element that may be included in the types of examples of the UI 106 just referenced, or similar examples, and that are used to control function(s) of the UI 106. For example, the UI elements 108, 110 may represent explicit selection elements intended to give the user 104 the option of making a selection in a context of the UI 106, such as to advance to a subsequent screen of the UI 106. In other examples, the UI elements 108, 110 may represent implicit selection elements that are not visually displayed by the UI elements 108, 110, such as when the user 104 controls operations of the UI 106 by performing one or more of a pre-defined set of head gestures, as described below.

For purposes of ease of explanation and understanding, in the remainder of the discussion of the simplified example of FIG. 1, the HMD 102 is generally described or referenced as smartglasses or goggles, with the UI 106 described as being displayed by display-related components of the smartglasses/goggles. As just referenced, however, such examples are non-limiting, and various other types and combinations of HMDs, UIs, and/or other devices may be used to implement the system of FIG. 1, some of which are illustrated and described, below.

Similarly, for purposes of the simplified example of FIG. 1, the UI element 108 and the UI element 110 are illustrated as displayed, selectable elements, such as, but not limited to, control elements or navigational elements. For example, the UI elements 108, 110 may include buttons, checkboxes, toggles, text fields, links, highlights, tabs, bars/sliders, menus, or any suitable type of icon(s) available in a display environment of the UI 106.

FIG. 1 illustrates an example x, y, z coordinate system that is common to both the user 104 and to the UI 106. For example, with respect to the user 104, an x direction may correspond to side-to-side head movements, a y direction may correspond to up-and-down head movements, and a z direction may correspond to forward-backward head movements. With respect to the UI 106, an x direction may correspond to left-right motions, and a y direction may correspond to up-down motions. A z direction may correspond to forward/backward motions when the UI 106 provides a 3D environment, and/or, as described below, may correspond to a selection motion with respect to the UI elements 108, 110. For example, a head movement of the user 104 in a forward z direction may correspond to a selection operation with respect to the UI element 108 or the UI element 110.

In order to provide UI control based on delta head movements as described herein, for example, a head movement of the user 104 may be detected and translated into a corresponding movement or operation with respect to the UI 106. For example, in the UI 106, an initialization point 112 may be defined with respect to the UI 106 (and/or with respect to individual UI elements 108, 110), and movement of a selection element 114 may be provided as a relative displacement 115 with respect to the initialization point 112, or other preceding location of the selection element 114.

For example, a delta head movement 113 of the user 104 is illustrated in FIG. 1 as a (Δx, Δy) movement of the head of the user 104, and corresponds to a magnified or amplified a (Δx, Δy) movement determined as a relative displacement 115 of the selection element 114 from the initialization point 112. For example, as described in more detail below, a current coordinate (x, y) of the selection element 114 at a current time t may be defined as the relative displacement 115 of the selection element 114 from a previous coordinate (x, y) of the selection element 114 at a preceding time (t−1). Put another way, the current coordinate of the selection element 114 may be provided as:

$${( x , y )}_{t} = {( x , y )}_{t - 1} + {α ( Δ x , Δ y )}_{t} . \qquad Eq . ( 1 )$$

As noted, in FIG. 1, the preceding coordinate of the selection element 114 is the initialization point 112. However, subsequent movements of the selection element 114 may be determined in a recursive manner, with respect to any preceding coordinate, so that movements of the selection element 114 may be controlled by the user 104 throughout an entirety of the UI 106. For example, the illustrated movement of the selection element 114 may represent movement from the initialization point 112 at a time (t−1) to the illustrated (x, y) coordinate of the selection element 114 at a time t. Then, a subsequent movement of the selection element 114 (not illustrated in FIG. 1) may occur relative to the illustrated (x, y) coordinate of the selection element 114 at the time t to a new (x, y) coordinate at a time (t+1), determined as a second relative displacement from the current (x, y) coordinate at time t.

Third and subsequent relative displacements may be determined in a recursive manner, with respect to corresponding delta head movements of the user 104, and which require little or no knowledge of any global or absolute coordinate system defined with respect to the UI 106, or otherwise. Instead, all such relative displacements may be determined with respect to the initialization point 112 and intervening relative displacements/coordinates. Consequently, the system of FIG. 1 is highly compatible with many different types of user interfaces, while requiring little or no calibration between the HMD 102 and a given UI being controlled.

Additionally, Eq. (1) above allows a desired customization in relating delta head movement 113 to relative displacement 115, simply by changing the factor a, referred to herein as a sensitivity factor. For example, as referenced above, it may be generally undesirable to require relatively large head movements on the part of the user 104 to obtain corresponding desired movements of the selection element 114 on the UI 106. On the other hand, some users may have physical limitations that limit their ability to provide small or fine head movements. Moreover, some users may simply have different preferences regarding a degree of head movement required to obtain a corresponding movement of the selection element 114.

In the system of FIG. 1, the above and related scenarios may be accommodated simply by updating the sensitivity factor a to obtain a desired correlation or sensitivity. The sensitivity factor a may thus be updated on a per user basis, and/or may be updated on a per UI basis, to accommodate different types and sizes of UIs. Further, the sensitivity factor a may be adjusted dynamically, e.g., as the user 104 progresses among different UI screens or contexts, or in response to other measurements that are concurrently captured while the UI 106 is being navigated.

Moreover, a degree of control required for the user 104 may be accommodated by updating a rendering of the UI 106 to match a degree of variance or jitter on the part of the user 104. For example, some users may exhibit a higher baseline of variance in movements relative to an average or default variance level. To accommodate such circumstances, the UI 106 may be re-rendered with more separation between displayed UI elements, represented in FIG. 1 by UI element 108a and UI element 110a. Consequently, the user 104 is provided with relatively relaxed requirements with respect to head movements needed by the HMD 102 to infer intent on the part of the user 104 in controlling the selection element 114.

In some cases, the UI 106 may be relatively large, such as when the HMD 102 provides an immersive 3D environment for the user 104. In some examples, the UI 106 may be too large to comfortably display within available screen space, and may have one or more portions that are illustrated in FIG. 1 as off-screen portion 116.

In such cases, as described in detail, below, the HMD 102 may detect a speed or acceleration of the selection element 114 in a given direction and during the above-described recursive, relative displacement movements of the selection element 114. As a result, the HMD 102 may predict the direction and timing of future relative displacements and associated direction(s), and may thereby pre-render a relevant portion of the off-screen UI 116. For example, in FIG. 1, if the user 104 exhibits a delta head movement in the positive x direction and towards a right edge of the UI 106 in FIG. 1, an off-screen UI element 118 may be pre-rendered while the selection element is still within the bounds of the currently rendered UI 106. As a result, a latency experienced by the user 104 in viewing and using the off-screen UI element 118 may be reduced.

To provide the above and related features, and as shown in the exploded view of FIG. 1, the HMD 102 may be configured with a number of hardware and software elements and features. For example, the HMD 102 may include a processor 120 (which may represent one or more processors), as well as a memory 122 (which may represent one or more memories (e.g., non-transitory computer readable storage media)). Although not shown separately in FIG. 1, the HMD 102 may also include a battery, which may be used to power operations of the processor 120, the memory 122, and various other resources of the HMD 102. As noted above, more detailed examples of the HMD 102 and various associated hardware/software resources, as well as alternate implementations of the system of FIG. 1, are provided below, e.g., with respect to FIGS. 7, 8A, and 8B.

For purposes of the simplified example of FIG. 1, the HMD 102 should be further understood to include at least one motion sensor 124. For example, the motion sensor 124 of FIG. 1 may represent one or more motion sensors, which may include, e.g., an accelerometer, magnetometer, gyroscope, or combination thereof (e.g., an inertial measurement unit (IMU)).

Further in FIG. 1, the HMD 102 may include a selection handler 126, which represents one or more of various techniques that may be implemented to enable use of the selection element 114 to trigger a function or feature of the UI 106 by selecting, e.g., one of the UI elements 108, 110, 118. For example, the user 104 may implement described techniques to move the selection element 114 in the context of the UI 106 and direct the selection element 114 to the UI element 110. The user 104 may then implement the selection handler 126 to select the UI element 110 and invoke a designated function of the UI element 110.

The selection handler 126 may represent any suitable or available selection technique. For example, the selection handler 126 may represent a hardware button on the HMD 102 that may be pressed by the user 104 to initiate a selection. In some examples, the HMD 102 may include a camera and gesture detector, and the selection handler 126 may detect a hand gesture of the user 104 for selection purposes. In other examples, the HMD 102 may include an eye tracker, and the selection handler 126 may detect a blink or other eye movement to execute a selection. Various other selection techniques may be used, some of which are described or referenced below.

A UI generator 128 refers to any application and associated hardware needed to generate the UI 106, including the off-screen portion 116. For example, the UI generator 128 may include a rendering engine and associated projector for generating the UI 106. More specific examples of the UI generator 128 are provided below, with respect to FIGS. 7, 8A, and 8B.

A buffer 130 represents a designated memory, or portion of the memory 122, configured to store sensor signals from the motion sensor 124 in a dynamic, ongoing manner. For example, the buffer 130 may store a most-recent n seconds of sensor data of one or more sensor signals from the motion sensor 124.

In more specific examples provided below, a head-based UI control manager 132 may be configured to utilize the sensor signals from the motion sensor 124, stored in the buffer 130, to instruct the UI generator 128 to enable the UI 106 and associated control of the selection element 114, as described herein. For example, in the examples referenced above, the head-based UI control manager 132 may capture overlapping windows of sensor signals stored in the buffer 130 to determine (x, y) coordinates (and relative displacements therebetween) at corresponding times (t−1), (t), (t+1).

As shown, the head-based UI control manager 132 includes a preprocessor 134 that is configured to extract sensor data from the buffer 130 and perform preprocessing of the extracted sensor data that is designed to improve operations of a relative displacement model 136. For example, the relative displacement model 136 may represent a neural network or other machine learning (ML) model trained to infer UI control intent of the user 104 with respect to the selection element 114, using the sensor data from the buffer 130. Then, the preprocessor 134 may be configured to modify (e.g., filter) the buffered sensor data in a manner(s) that optimizes operations of the relative displacement model 136.

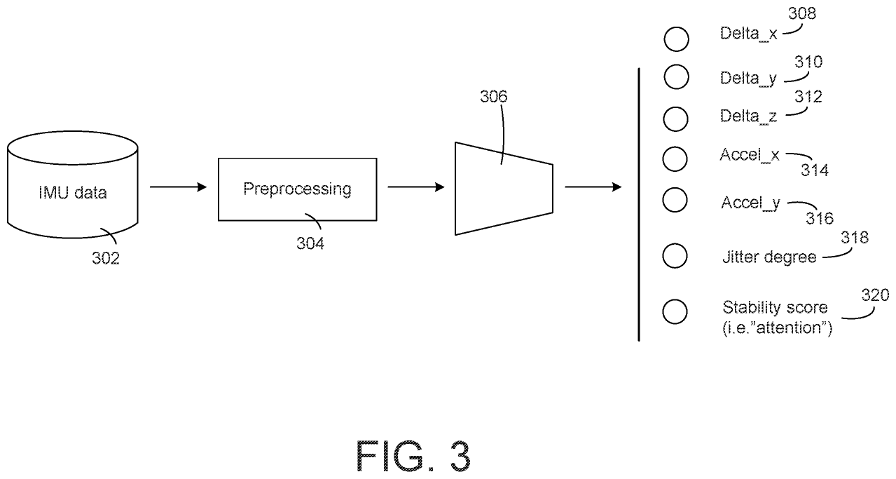

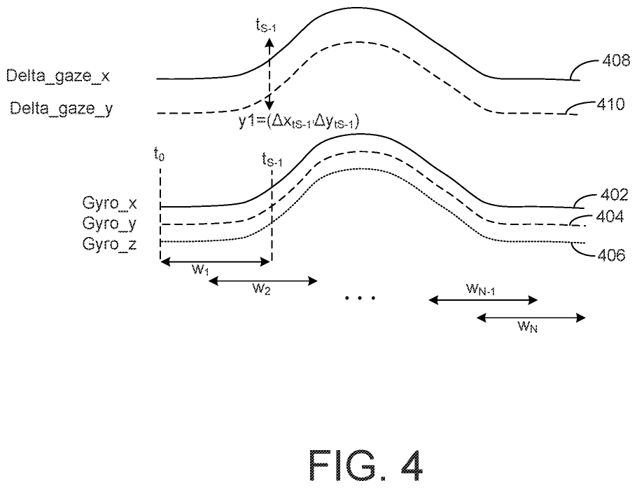

For example, in the above examples in which sensor data is captured and buffered over multiple, overlapping time windows, the preprocessor 134 may determine an average value for each received sensor signal over each received time window, and then, e.g., subtract this average value from a value selected for further processing. Such an approach may serve to reduce noise in each processed signal that might otherwise be misinterpreted by the relative displacement model 136 when inferring user intent with respect to controlling the selection element 114 (e.g., may result in an unwanted drift of the selection element 114). Additional and more detailed examples of operations of the preprocessor 134 are provided below, e.g., with respect to FIGS. 3 and 4.

The relative displacement model 136, as just referenced, may refer to any suitable ML model. For example, the relative displacement model 136 may be implemented using a deep neural network, e.g., a convolutional regressor, to estimate a delta head movement(s) and to thereafter recursively update relative displacements and associated UI coordinates of the selection element 114. In other examples, a multi-layer perceptron (MLP) model, a multi-layer feed forward neural network, a multi-headed input convolutional neural network (CNN), or other suitable model(s) may be used.

In any such implementation(s), and as described and illustrated in more detail with respect to FIG. 3, the relative displacement model 136 may be constructed with a linear output layer that is designed and trained to provide continuous output values. As a result, movement of the selection element 114 may be provided in a smooth, continuous manner when rendered in the context of the UI 106.

Although the delta head movement 113 and the relative displacement 115 are described above in terms of (x, y) coordinates, the relative displacement model 136 may be further trained and configured to determine the delta head movement 113 and relative displacement 115 in a z direction, as well. For example, when the UI 106 includes a 3D display, the z direction of delta head movement 113 may be used to indicate control of the selection element 114 in a corresponding z direction of the relative displacement 115, as well.

In other examples, head movements in a z direction may be used in the context of the selection handler 126, or to perform some other desired function with respect to the UI 106. For example, rather than having separate selection hardware element(s) (e.g., button), the user 104 may select a desired UI element 108, 110, 118 by directing the selection element 114 accordingly and then performing a head movement in the z direction (e.g., a forward head motion).

Moreover, and as also described in more detail with respect to FIG. 3, the output layer of the relative displacement model 136 may be trained to output additional metadata with respect to the selection element 114, and associated inferred intentions of the user 104 with respect to use/control of the selection element 114. For example, the relative displacement model 136 may be trained and configured to output metadata characterizing a stability of head movements of the user 104, an acceleration of head movements of the user 104, and/or a variance or jitter of head movements of the user 104. As referenced above, such metadata may be useful in improving a latency and/or accuracy of the head-based UI control manager 132 in providing control of the selection element 114 to the user 104.

For example, by outputting metadata characterizing an acceleration of the delta head movement(s) 113 of the user 104, the relative displacement model 136 enables an acceleration manager 138 to manage operations of the UI generator 128 in rendering, or pre-rendering, the UI 106 and associated content. As already described, the acceleration manager 138 may determine that the user 104 is exhibiting delta head movement(s) 113 that correspond to relative displacements of the selection element 114 in a direction of the off-screen UI element 118 and at an associated acceleration. Consequently, the acceleration manager 138 may instruct the UI generator 128 to pre-render the portion of the off-screen UI 116 that is associated with the off-screen UI element 118.

Similarly, the acceleration manager 138 may instruct the UI generator 128 to pre-render a separate (e.g., linked) screen that is associated with selection or invocation of a UI element 108, 110, or 118, based on acceleration metadata obtained from the relative displacement model 136. For example, the off-screen UI element 118 may represent a link to a separate page or other resource associated with the UI 106. By instructing such pre-rendering operations, the acceleration manager 138 may reduce a latency experienced by the user 104 in navigating the UI 106 and related resources.

A variance manager 140 may be configured to utilize variance metadata generated by the relative displacement model 136, to thereby account for a determined degree of variance or jitter in head movements of the user 104. For example, the user 104 may exhibit greater or lesser degrees of a baseline level of variance in head movements. The variance manager 140 may be configured to instruct the UI generator 128 to account for such variance by, e.g., altering relative proportions of, or distances between, UI elements of the UI 106. For example, as described above, the variance manager 140 may instruct the UI generator 128 to render the UI 106 with the modified UI elements 108a, 110a, spaced farther apart from one another than original UI elements 108, 110. Conversely, if the user 104 exhibits lesser levels of variance in head movements, UI elements 108, 110 might be placed closer together, e.g., a greater number of UI elements may be provided within a given area of the UI 106.

A sensitivity manager 142 may be configured to calibrate, update, and otherwise manage a value of the sensitivity factor a in Eq. (1), above. As noted with respect to Eq. (1), the sensitivity factor a may be used to dictate or characterize a relationship between the delta head movement 113 of the user 104 and the relative displacement 115 of the selection element 114.

For example, some users may prefer a high sensitivity, so that small head movements translate to relatively large movements of the selection element 114. Such users may thus be provided with discrete use of the delta head movement techniques described herein; that is, head movements of the user 104 needed to control the selection element 114 may be small and less noticeable to any other persons who may be present in a vicinity of the user 104

Conversely, the user 104 may prefer a low sensitivity, so that more definitive (e.g., larger) head movements may be utilized to determine corresponding movements of the selection element 114. Such sensitivity settings may provide relatively enhanced accuracy, albeit with more noticeable head movements.

In some scenarios, the sensitivity manager 142 may operate in conjunction with the variance manager 140. For example, the variance manager 140 may instruct the sensitivity manager 142 to increase/decrease the sensitivity factor a in response to greater/lesser detected quantities of variance, rather than, or in addition to, instructing the UI generator 128 to update relative proportions of the UI 106.

Detected variance may be transitory or longer-term, and operations of the variance manager 140 and/or the sensitivity manager 142 may be updated accordingly. For example, short-term or intermittent increases in variance may occur when the user 104 is walking, as compared to standing still, while longer-term or persistent levels of variance may be related to a medical condition or other particular circumstances of the user 104.

Finally in the example of FIG. 1, a stability manager 144 may be configured to receive stability metadata from the relative displacement model 136. In this context, the term stability refers to a duration of relative or complete lack of head movement of the user 104.

In particular, the user 104 may direct the selection element 114 within the UI 106 as described, with the intent of selecting the UI element 110. During a time after the selection element 114 reaches the UI element 110 and before the user 104 invokes the selection handler 126 to select the UI element 110, head movements of the user 104 may be relatively or absolutely stable with respect to preceding head movements associated with directing the selection element 114. Put another way, the user 104 may exhibit a pause between identifying and selecting the UI element 110.

This pause may be determined by the relative displacement model 136 and used by the stability manager 144 to infer an imminent selection of the UI element 110. Therefore, similar to the acceleration manager 138, the stability manager 144 may instruct the UI generator 128 to pre-render a UI resource associated with selection of the UI element 110. As a result, the user 104 may experience reduced latency when selecting the UI element 110, as compared to when the stability manager 144 is not available.

In the example of FIG. 1, the relative displacement model 136 may be configured to provide the described control of the selection element 114, while also providing the various types of metadata described. Each of the acceleration manager 138, the variance manager 140, the sensitivity manager 142, and the stability manager 144 may be configured or customized to provide varying extents, degrees, or kinds of their respective functions, individually or in collaboration with one another.

For example, the acceleration manager 138 and/or the stability manager 144 may be configured to provide varying extents of pre-rendering, to provide corresponding levels of latency reduction. In other examples, the variance manager 140 and the sensitivity manager 142 may provide coordinated adjustments that enable the user 104 to control the UI 106 in a desired manner and with corresponding types/degrees of head movements.

In FIG. 1, the various components of the HMD 102 are illustrated as being present within (e.g., mounted on or in) the HMD 102. For example, the various components may be provided using a glasses frame when the HMD 102 represents a pair of smartglasses.

The illustrated components of the head-based UI control manager 132 may be implemented as one or more software module(s). That is, for example, the memory 122 may be used to store instructions that are executable by the processor 120, which, when executed, cause the processor 120 to implement the head-based UI control manager 132 as described herein.

As referenced above and shown in more detail with respect to FIG. 7, various ones of the illustrated components of the HMD 102, e.g., components of the head-based UI control manager 132, may be provided in a separate device that is in communication with the HMD 102. For example, the selection handler 126 may utilize or be in communication with a smartwatch or smartphone that provides a selection feature. In other examples, one or more components of the head-based UI control manager 132 may be provided using a separate device(s), including a remote (e.g., cloud-based) device.

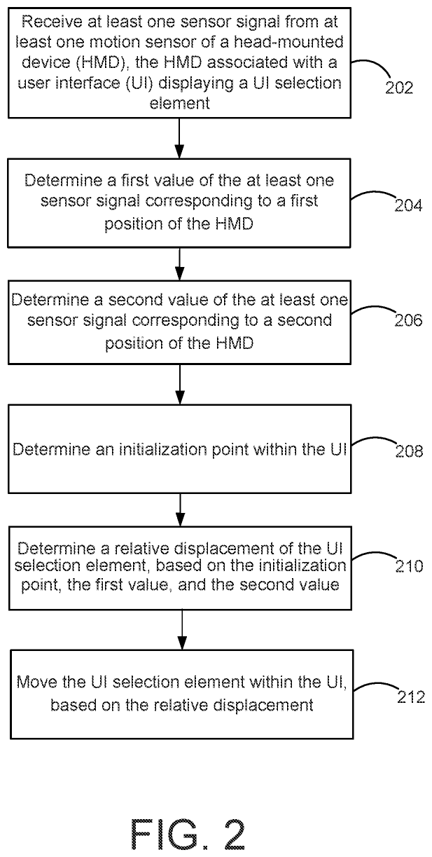

FIG. 2 is a flowchart illustrating example operations of the system of FIG. 1. In the example of FIG. 2, operations 202-14 are illustrated as separate, sequential operations. However, in various example implementations, the operations 202-214 may be implemented in a different order than illustrated, in an overlapping or parallel manner, and/or in a nested, iterative, looped, or branched fashion. Further, various operations or sub-operations may be included, omitted, or substituted.

In FIG. 2, at least one sensor signal may be received from at least one motion sensor of a head-mounted device (HMD), the HMD associated with a user interface (UI) displaying a UI selection element (202). For example, in FIG. 1, one or more sensor signals may be received from the motion sensor(s) 124, e.g., IMUs, of the HMD 102, and buffered at the buffer 130. As described, the UI 106 may be a UI generated or projected by the HMD 102, or may be a separate monitor or display being viewed by the user 104. The UI selection element 114 may include any pointer, cursor (e.g., arrow cursor or text cursor), or any type of interactive element that may be used to select or otherwise control some aspect of the UI 106.

A first value of the at least one sensor signal corresponding to a first position of the HMD may be determined (204). For example, as referenced above and illustrated below with respect to FIG. 4, the first sensor signal value(s) may be determined as an average of each of sensor signal x, y, z channels within the buffer 130 over a first defined time window, during which a head direction of the user 104 is determined to be defined by, or with respect to, the first position of the HMD. The average value may be used to determine the first value, e.g., the average value may be subtracted from a final or other selected value to obtain the first value.

A second value of the at least one sensor signal corresponding to a second position of the HMD may be determined (206). For example, as described with respect to the first sensor signal, the second sensor signal may be determined using an average of each of sensor signal x, y, z channels within the buffer 130 over a second defined time window, which may overlap with the first defined time window.

An initialization point within the UI may be determined (208). For example, in FIG. 1, the initialization point 112 is illustrated as a centroid of the UI elements 108, 110. More generally, the initialization point 112 may be defined as a centroid of all of a visible set of UI elements of the UI 106.

In other examples, the initialization point 112 may be defined as a center of the UI 106. In other examples, such as when displayed UI elements have an inherent, implied, likely, or express order, the initialization point 112 may be associated with a single UI element, e.g., a first UI element.

The initialization point 112 may be visually highlighted or otherwise identified within the UI 106. For example, when the UI 106 is initially rendered or displayed, the initialization point 112 may be visible and the first value of the at least one sensor signal, and thus the first position of the HMD (head position of the user 104), may be assumed to be aligned with the first position/initialization point 112. For example, the user 104 may be instructed to view the initialization point 112 upon an initial display of the UI 106.

A relative displacement of the UI selection element may be determined, based on the initialization point, the first value, and the second value (210). For example, the first value and the second value of the sensor signal(s), representing the delta head movement 113 of the user 104, may each be preprocessed by the preprocessor 134 and fed to the relative displacement model 136. The relative displacement model 136 may output the relative displacement, e.g., the relative displacement 115.

The UI selection element may thus be moved within the UI, based on the relative displacement (212). For example, the relative displacement model 136 may output the relative displacement to the UI generator 128 for continuous movement of the selection element 114. As described, portions of the operations of FIG. 2 may be repeated with subsequent buffered values of the sensor signals, to enable recursive calculations of relative displacements of the selection element 114, and thus provide delta head-based control of the selection element 114 to the user 104.

As also noted above, the relative displacement model 136 may provide additional outputs of metadata that may be used to improve or enhance a UI experience of the user 104. FIG. 3 is a block diagram of an example system that may be used in the system of FIG. 1 and that illustrates examples of such metadata, consistent with the examples of FIG. 1.

In FIG. 3, similar to FIG. 1, IMU data 302 reflecting head direction(s)/head movement(s) is used to implement movement-semantics based control that does not require an absolute positioning estimate. Described techniques may thus be understood by way of analogy to operations of a computer mouse moved by a user's hand to control cursor movement based on, e.g., changes in light reflected from a surface and sensed at an optical sensing element of the mouse.

In FIG. 3, preprocessing 304 may reflect any desired cleaning, sanitization, filtering, or other data manipulation that may cause the processed data to be more useful when further processed by a relative displacement model 306. More detailed examples of preprocessing 304 are provided below, with respect to FIG. 4.

By way of example, when buffering sensor values over a time window, a mean value of the sensor value over the time window may represent a baseline value that may cause a potential drift in the selection element 114. Therefore, preprocessing 304 may calculate and subtract a mean value over each time window of collection of sensor values, in order to minimize or eliminate such drift.

In other examples, a digital filter (e.g., finite impulse response filter) may be implemented as part of the preprocessing 304. For example, a digital filter may be implemented by tuning a cutoff frequency determined from a drift frequency of the filter, to thereby separate a drift component(s) from desired components of the sensor values.

Various other types of preprocessing 304 may be performed, as well. Moreover, such preprocessing may vary by implementation and/or design choice. For example, when the system of FIG. 3 is used for avatar control, head movements that might be filtered out for purposes of cursor control may be retained.

The relative displacement model 306 of FIG. 3 may be configured to solve a regression problem (e.g., using a convolutional regressor design) of estimating continuous values of relative displacements, based on the preprocessed sensor signal values corresponding to delta head movements of the user 104. As referenced above, and illustrated in FIG. 3, an output layer of the relative displacement model 306 may be linearized to obtain such continuous values within outputs that are defined from a range of negative values for x, y, z, coordinates to a range of positive values for the x, y, z, coordinates, to thereby provide coverage across a full surface or area of a UI, such as the UI 106 of FIG. 1.

As shown, the relative displacement model 306 thus provides movement-descriptive nodes 308-320 that compressively describe movement semantics of head movements of the user 104. Specifically, a node 308 provides delta_x movements, a node 310 provides delta_y movements, and a node 312 provides delta_z movements. Accordingly, relative displacements may be computed in a similar way that a physical mouse takes a trajectory when moved. In this way, for example, invisible cursor behavior during overhead Augmented Reality (AR) display selection may be described, or, more generally, any desired control of the selection element 114 may be provided.

A node 314 provides accel_x values representing acceleration in an x direction, while a node 316 provides accel_y values representing acceleration in an y direction. As described above, nodes 314, 316 enable calculation of an acceleration in an (x, y) plane, or, put another way provides an acceleration cue that is 2D-projected into a UI space.

Such an acceleration cue may be used to provide predictive control based on a determined quickness of moving from one UI option to another. For example, if the user 104 intends to move from a first option at the left of an AR screen to a second option at the right of the AR screen, then accel_x,y may be determined to be high at a time t_0. Then, delta_x,y information may be amplified using accel_x,y to determine that at time t_1 the selection element 114 (e.g., invisible cursor) may be predicted to be lying on the second option. As the user's head physically moves to the second option at time t_2, the pre-computed cursor may be used to improve a display reaction and mask any latency (e.g., with respect to UI rendering or fetching of remote data) that might otherwise be experienced by the user 104. As referenced with respect to FIG. 1, the second option in the above example may be off-screen or may be at a periphery of a currently rendered screen.

A node 318 represents an example of variance described above with respect to FIG. 1. That is, the node 318 may provide a measure (e.g., in angles) of an average or baseline degree of jitter in angles of a head of the user 104. As noted above, such measurements may reflect non-UI related movements, which may be transient (e.g., moving/walking) or permanent for the user 104. Then, for example, this measurement(s) may be used to reduce false selections when interacting with the UI 106.

In a more specific example, it may occur that a jitter degree for the user 104 is determined to be, e.g., 3 degrees. Then, UI elements may be expanded to a sufficient degree (e.g., a corresponding or relative number of degrees) that the user 104 does not experience indeterminate selection (e.g., flickering) between the UI elements.

In a final aspect of FIG. 3, a node 320 represents a stability score that characterizes an overall stability of head position of the user 104 at a point(s) in time, so that the stability score is correlated with, or may be used to represent, user attention. As a result, and as described above, the determined user attention may be used to determine predictive inputs of the user 104.

For example, if the determined stability score is high (e.g., above a stability threshold) on a first UI element/option, then subsequent screen options corresponding to a selection of the first UI element/option may be pre-computed in split compute operations that are not displayed to the user 104. Then, once the first UI element/option is explicitly selected (e.g., by a separate confirm gesture performed by the user 104), the pre-computed assets may be immediately loaded/rendered and displayed. Consequently, compared to a conventional approach of computing input results and rendering all assets at selection time, the described predictive control allows for a split-compute that masks overall latency for the user 104.

In some implementations, the jitter degree of the node 318 and the stability score of the node 320 may be correlated. For example, the jitter degree may be used in part to determine the stability score. The example of FIG. 3 illustrates that it is useful to determine these measures separately in order to facilitate direct use of each parameter by different logic operations.

FIG. 4 illustrates example pre-processing techniques that may be used in the example of FIG. 3. In FIG. 4, a gyroscope is assumed as an example of the motion sensor 124 of FIG. 1. A signal 402 represents values of a sensor signal of the gyroscope in an x direction (an x-direction signal), a signal 404 represents values of a sensor signal of the gyroscope in a y direction (a y-direction signal), and a signal 406 represents values of a sensor signal of the gyroscope in a z direction (a z-direction signal). The signals 402, 404, 406 may be processed to obtain a signal 408 that represents a delta head movement of the user 104 in an x direction, and a signal 410 that represents a delta head movement of the user 104 in a y direction.

As illustrated in FIG. 4, to prepare sensor data 402, 404, 406 (corresponding to an example of IMU data 302 of FIG. 3) to be fed to the relative displacement model 306, each recorded session may be divided into N overlapping windows w₁ . . . w_{N} of size M. The delta head movement associated with a final time stamp in a given window may be considered to provide a ground truth label yᵢ for that window. For example, a window w₁ is illustrated as occurring between time t₀ and time t_{(S-1)}, and is associated with a label y₁. More generally, for windows wᵢ=[Sₜ₀, . . . , S_{t(S-1)}] for i∈{1, . . . , N}, yᵢ may be written as (Δxₜ₍ₛ₋₁₎, Δyₜ₍ₛ₋₁₎).

Many different window sizes and overlap percentages may be implemented. For example, window sizes between 20-80 ms may be used, and/or overlap percentages of, e.g., 50-80% may be used.

As described above, an average value over a given time window wᵢ may be determined. The average value may either be used for further processing, or may be subtracted from a final value to obtain a value for further processing. In other examples, a digital filter may be applied to the sensor signals 402, 404, 406

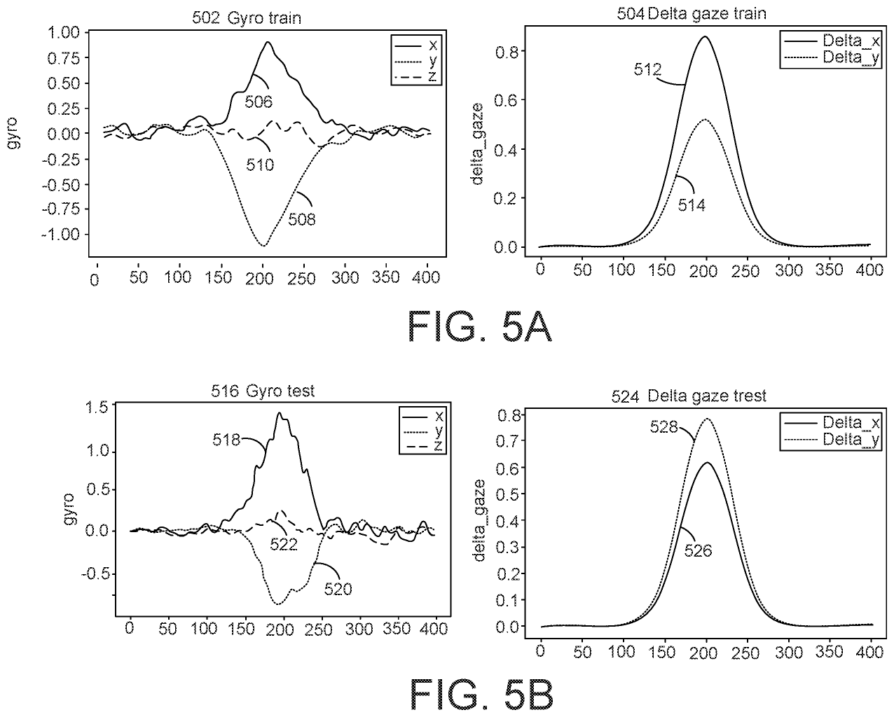

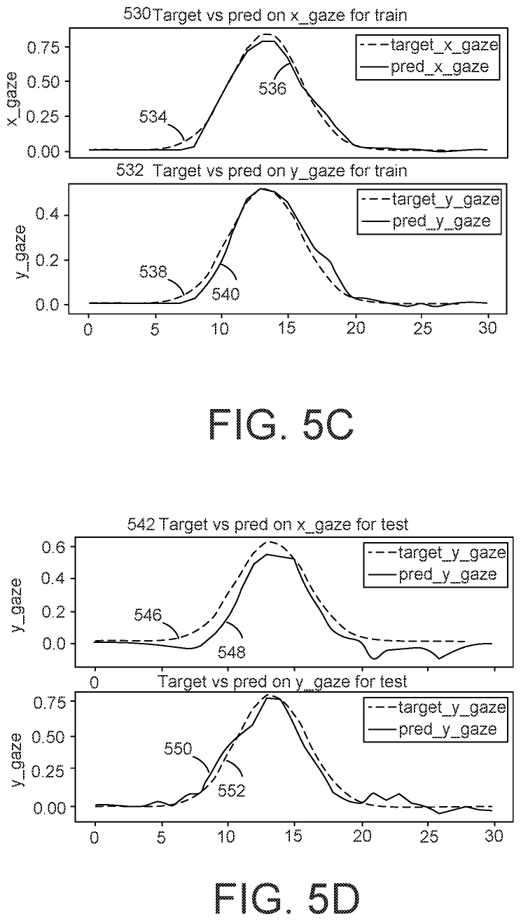

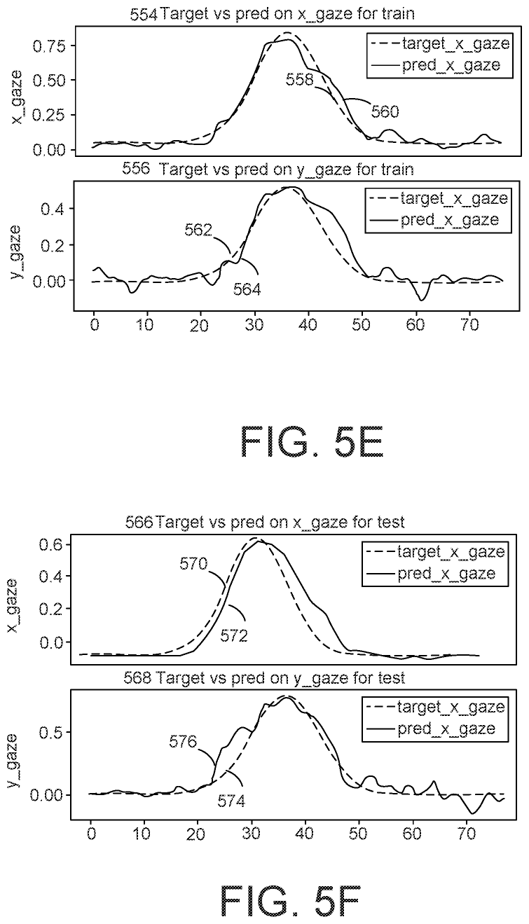

FIG. 5A illustrates graphs showing example training data used in the example of FIG. 3, and FIG. 5B illustrates graphs showing example test results data of the example of FIG. 3. In the examples of FIGS. 5A and 5B, raw IMU data is encoded with ground truth screen (x, y) information during training and subsequent testing representative of multiple recording sessions.

For example, various recording sessions of an individual for training (FIG. 5A) and testing (FIG. 5B) may include, for each recording session, a known number of samples recorded on the x-axes, across a corresponding time period sec associated with sampling at a defined frequency. Consistent with the example of FIG. 4, each time stamp may be associated with 3 gyroscope channels (gyro_x, gyro_y, gyro_z) as input and a corresponding relative displacement (Δx, Δy) as its label.

Thus, FIG. 5A may be understood to include a graph 502 representing an example recording session for training purposes, while a graph 504 represents corresponding relative displacements of the training session. As shown in the graph 502, a signal 506 represents gyroscope data for an x channel, a signal 508 represents gyroscope data for a y channel, and a signal 510 represents gyroscope data for a z channel. As shown in the graph 504, a signal 512 represents a Δx displacement, while a signal 514 represents a Δy displacement. In other words, FIG. 5A may be understood to illustrate a movement of a user's head, as captured from the HMD 102, from a center position to an downward/right direction and back to the center position, with corresponding relative displacements illustrated in the graph 504.

FIG. 5B illustrates similar results from a testing phase. As shown, FIG. 5B includes a graph 516 representing an example recording session for testing purposes, while a graph 524 represents corresponding relative displacements of the testing session. As shown in the graph 516, a signal 518 represents gyroscope data for an x channel, a signal 520 represents gyroscope data for a y channel, and a signal 522 represents gyroscope data for a z channel. As shown in the graph 524, a signal 526 represents a Δx displacement, while a signal 528 represents a Δy displacement.

As referenced above, the obtained relative displacements may be analogized to relative displacements of a cursor controlled by a conventional mouse. Consequently, in the training of the relative displacement model 306 as illustrated in the context of FIGS. 5A and 5B, it is possible to directly borrow a physical mouse as a ground truth tool. For example, an extended IMU sensor may be attached to a physical mouse to enable synchronized data streaming, thereby enabling collection of IMU-mouse semantics correspondence data. As a result, supervised learning of deep convolutional regressors may be performed in a fast, inexpensive, and efficient manner that is applicable to multiple types of devices, including the HMD 102 of FIG. 1.

The graphs of FIGS. 5C-5F demonstrate example differences between ground truth data and predicted Δx, Δy on a randomly selected recording session. Success of obtained results may be evaluated, e.g., based on root mean square error (RMSE).

More specifically, FIG. 5C illustrates graphs showing example training data for a first example machine learning model, and FIG. 5D illustrates graphs showing example test data for the example machine learning model of FIG. 5C. Specifically, the examples of FIGS. 5C and 5D may correspond to a MLP model with 3 hidden layers with ReLU activation and a dropout layer.

Similarly, FIG. 5E illustrates graphs showing example training data for a second example machine learning model, and FIG. 5F illustrates graphs showing example test data for the example machine learning model of FIG. 5E. Specifically, the examples of FIGS. 5E and 5F correspond to a CNN model that includes 2 convolutional blocks followed by one fully connected layer, in which each convolutional block includes 2 convolutional layers with ReLU activation followed by a max pooling layer.

As referenced above, each model may input a fixed length window of gyroscope samples and output a corresponding Δx, Δy relative displacement. During training, a suitable optimizer, learning rate, batch size, number of training epochs, and any other parameter(s) may be selected. Similarly, any suitable loss function may be used, e.g., mean squared error (MSE).

In FIG. 5C, for the example of the MLP model referenced above, a graph 530 illustrates a detected head movement (target) signal 534 in an x direction and a corresponding predicted Δx signal 536 obtained during training. A graph 532 illustrates a detected head movement (target) signal 538 in a y direction and a corresponding predicted Δy signal 540 obtained during training.

In FIG. 5D, for the example of the MLP model referenced above, a graph 542 illustrates a detected head movement (target) signal 546 in an x direction and a corresponding predicted Δx signal 548 obtained during testing. A graph 544 illustrates a detected head movement (target) signal 552 in a y direction and a corresponding predicted Δy signal 550 obtained during testing.

In FIG. 5E, for the example of the CNN model referenced above, a graph 554 illustrates a detected head movement (target) signal 558 in an x direction and a corresponding predicted Δx signal 560 obtained during training. A graph 556 illustrates a detected head movement (target) signal 562 in a y direction and a corresponding predicted Δy signal 564 obtained during training.

In FIG. 5F, for the example of the CNN model referenced above, a graph 566 illustrates a detected head movement (target) signal 570 in an x direction and a corresponding predicted Δx signal 572 obtained during testing. A graph 568 illustrates a detected head movement (target) signal 574 in a y direction and a corresponding predicted Δy signal 576 obtained during testing.

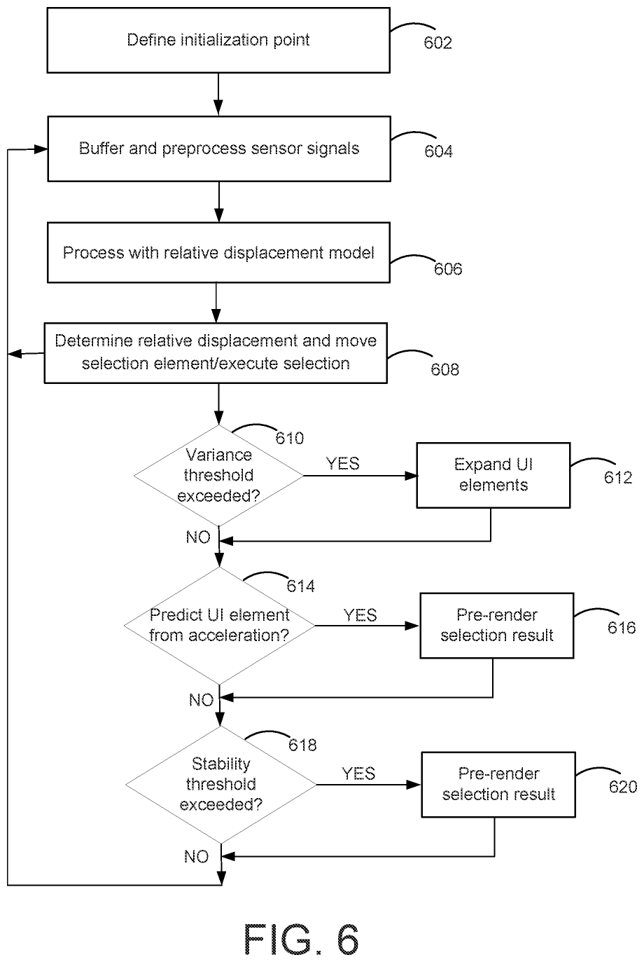

FIG. 6 is a flowchart illustrating example operations of the systems of FIGS. 1 and 3. In the example of FIG. 6, for a given UI, an initialization point may be defined (602). For example, a size, perimeter, or boundary of the UI may be determined, and the initialization point may be determined at a corresponding center value. The initialization point may also be determined as a mathematical mean of positions of selectable elements, or using any other suitable technique. The initialization point may be reinitialized in response to a user request, or after a predetermined period of use, and/or if a drift or other inaccuracy is detected.

Sensor signals corresponding a user's delta head movements may be buffered and preprocessed (604), to thereafter be processed with a previously trained relative displacement model (606). Accordingly, a relative displacement may be determined, and a selection element may be moved, e.g., to execute or invoke a desired selection (608).

Along with relative displacement values, e.g., in an x, y, z direction(s), the relative displacement model may output various other types of metadata, including variance (jitter), acceleration, and stability metadata. Therefore, in the example of FIG. 6, if a variance threshold is determined to be exceeded (610), UI elements may be expanded (612) to reduce the chances of flicker and enable more reliable use of a selection element.

If a UI element can be predicted from determined acceleration metadata (614), then a selection result of the predicted UI element may be pre-rendered, pre-computed, or otherwise pre-determined (616). Somewhat similarly, if a stability threshold is exceeded with respect to a selectable UI element (618), then a selection result of the selectable UI element may be pre-rendered, pre-computed, or otherwise pre-determined (620).

Although shown in a generally serialized fashion in FIG. 6, it will be appreciated that determined measurements and outputs may be calculated recursively and iteratively, using multiple loops, and/or may be calculated in parallel. For example, relative displacement coordinates may be determined (608) at each measurement cycle, while one or more of the available types of metadata may be inspected/updated less frequently, or only in response to a defined trigger.

Moreover, various other operations, not specifically shown in FIG. 6, may be implemented. For example, if a variance threshold is below a defined threshold, separation between UI elements may be reduced. In other examples, as referenced above, a sensitivity factor of the relative displacement model may be dynamically or manually updated. For example, upon an initial use of the HMD 102, the user 104 may be asked to perform one or more head movements and selection operations, in order to determine a preferred sensitivity factor and otherwise calibrate usage for the preferences or characteristics of the user 104.

FIGS. 1-6 illustrate that relatively fine or small head movements may be used to reliably control relative displacements of a UI selection element, even when the head movements are captured in the context of noisy motion sensor data. Consequently, a framework providing a natural, easy-to-use interface may be provided, which is generalizable across, e.g., glasses, goggles, wristbands, and smartphones. By interpreting head tracking using differential gaze estimation rather than an absolute gaze estimation, as described herein, unique advantageous may be provided, including, e.g., engineered precision based on natural human movement, little or no calibration requirements, and less dependence on device-to-device variation or UI variation. Conventional head gaze solutions may be formulated as discrete problems, i.e., mapping raw IMU to head elements, and may therefore rely heavily on UI layout assumptions, thereby limiting scalability of such solutions. In contrast, described techniques eliminate the need for such prior knowledge, e.g., by formulating the head tracking problem as a continuous framework. As described, a deep neural network, e.g., a convolutional regressor, may be used to estimate delta head movements, which may be further used to recursively update relative displacements of a corresponding UI element.

FIG. 7 is a third person view of a user 702 (analogous to the user 104 of FIG. 1) in an ambient environment 7000, with one or more external computing systems shown as additional resources 752 that are accessible to the user 702 via a network 7200. FIG. 7 illustrates numerous different wearable devices that are operable by the user 702 on one or more body parts of the user 702, including a first wearable device 750 in the form of glasses worn on the head of the user, a second wearable device 754 in the form of ear buds worn in one or both ears of the user 702, a third wearable device 756 in the form of a watch worn on the wrist of the user, and a computing device 706 held by the user 702. In FIG. 7, the computing device 706 is illustrated as a handheld computing device but may also be understood to represent any personal computing device, such as a table or personal computer.

In some examples, the first wearable device 750 is in the form of a pair of smart glasses including, for example, a display, one or more images sensors that can capture images of the ambient environment, audio input/output devices, user input capability, computing/processing capability and the like. Additional examples of the first wearable device 750 are provided below, with respect to FIGS. 8A and 8B.

In some examples, the second wearable device 754 is in the form of an ear worn computing device such as headphones, or earbuds, that can include audio input/output capability, an image sensor that can capture images of the ambient environment 7000, computing/processing capability, user input capability and the like. In some examples, the third wearable device 756 is in the form of a smart watch or smart band that includes, for example, a display, an image sensor that can capture images of the ambient environment, audio input/output capability, computing/processing capability, user input capability and the like. In some examples, the handheld computing device 706 can include a display, one or more image sensors that can capture images of the ambient environment, audio input/output capability, computing/processing capability, user input capability, and the like, such as in a smartphone. In some examples, the example wearable devices 750, 754, 756 and the example handheld computing device 706 can communicate with each other and/or with external computing system(s) 752 to exchange information, to receive and transmit input and/or output, and the like. The principles to be described herein may be applied to other types of wearable devices not specifically shown in FIG. 7 or described herein.

The user 702 may choose to use any one or more of the devices 706, 750, 754, or 756, perhaps in conjunction with the external resources 752, to implement any of the implementations described above with respect to FIGS. 1-6. For example, the user 702 may use an application executing on the device 706 and/or the smartglasses 750 to execute the head-based UI control manager 132 of FIG. 1.

As referenced above, the device 706 may access the additional resources 752 to facilitate the various UI-related operations described herein, or related techniques. In some examples, the additional resources 752 may be partially or completely available locally on the device 706 or the first wearable device (HMD) 750. In some examples, some of the additional resources 752 may be available locally on the device 706, and some of the additional resources 752 may be available to the device 706 via the network 7200. As shown, the additional resources 752 may include, for example, server computer systems, processors, databases, memory storage, and the like. In some examples, the processor(s) may include training engine(s), transcription engine(s), translation engine(s), rendering engine(s), and other such processors. In some examples, the additional resources may include ML model(s).

The device 706 (and or the first wearable device (HMD) 750) may operate under the control of a control system 760. The device 706 can communicate with one or more external devices, either directly (via wired and/or wireless communication), or via the network 7200. In some examples, the one or more external devices may include various ones of the illustrated wearable computing devices 750, 754, 756, another mobile computing device similar to the device 706, and the like. In some implementations, the device 706 includes a communication module 762 to facilitate external communication. In some implementations, the device 706 includes a sensing system 764 including various sensing system components. The sensing system components may include, for example, one or more image sensors 765, one or more position/orientation sensor(s) 764 (including for example, an inertial measurement unit, an accelerometer, a gyroscope, a magnetometer and other such sensors), one or more audio sensors 766 that can detect audio input, one or more image sensors 767 that can detect visual input, one or more touch input sensors 768 that can detect touch inputs, and other such sensors. The device 706 can include more, or fewer, sensing devices and/or combinations of sensing devices. Various ones of the various sensors may be used individually or together to perform the types of UI control described herein.

Captured still and/or moving images may be displayed by a display device of an output system 772, and/or transmitted externally via a communication module 762 and the network 7200, and/or stored in a memory 770 of the device 706. The device 706 may include one or more processor(s) 774. The processors 774 may include various modules or engines configured to perform various functions. In some examples, the processor(s) 774 may include, e.g, training engine(s), transcription engine(s), translation engine(s), rendering engine(s), and other such processors. The processor(s) 774 may be formed in a substrate configured to execute one or more machine executable instructions or pieces of software, firmware, or a combination thereof. The processor(s) 774 can be semiconductor-based including semiconductor material that can perform digital logic. The memory 770 may include any type of storage device or non-transitory computer-readable storage medium that stores information in a format that can be read and/or executed by the processor(s) 774. The memory 770 may store applications and modules that, when executed by the processor(s) 774, perform certain operations. In some examples, the applications and modules may be stored in an external storage device and loaded into the memory 770.

Although not shown separately in FIG. 7, it will be appreciated that the various resources of the computing device 706 may be implemented in whole or in part within one or more of various wearable devices, including the illustrated smartglasses 750, as well as the earbuds 754 and smartwatch 756, any or all of which may be in communication with one another to provide the various features and functions described herein.

An example head mounted wearable device 800 in the form of a pair of smart glasses is shown in FIGS. 8A and 8B, for purposes of discussion and illustration. The example head mounted wearable device 800 includes a frame 802 having rim portions 803 surrounding glass portion, or lenses 807, and arm portions 830 coupled to a respective rim portion 803. In some examples, the lenses 807 may be corrective/prescription lenses. In some examples, the lenses 807 may be glass portions that do not necessarily incorporate corrective/prescription parameters. A bridge portion 809 may connect the rim portions 803 of the frame 802. In the example shown in FIGS. 8A and 8B, the wearable device 800 is in the form of a pair of smart glasses, or augmented reality glasses, simply for purposes of discussion and illustration.

In some examples, the wearable device 800 includes a display device 804 that can output visual content, for example, at an output coupler providing a visual display area 805, so that the visual content (e.g., a user interface) is visible to the user. In the example shown in FIGS. 8A and 8B, the display device 804 is provided in one of the two arm portions 830, simply for purposes of discussion and illustration. Display devices 804 may be provided in each of the two arm portions 830 to provide for binocular output of content. In some examples, the display device 804 may be a see through near eye display. In some examples, the display device 804 may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through.

Such an optic design may allow a user to see both physical items in the world, for example, through the lenses 807, next to content (for example, digital images, user interface elements, virtual content, and the like) output by the display device 804. In some implementations, waveguide optics may be used to depict content on the display device 804.

The example wearable device 800, in the form of smart glasses as shown in FIGS. 8A and 8B, includes one or more of an audio output device 806 (such as, for example, one or more speakers), an illumination device 808, a sensing system 810, a control system 812, at least one processor 814, and an outward facing image sensor 816 (for example, a camera). In some examples, the sensing system 810 may include various sensing devices and the control system 812 may include various control system devices including, for example, the at least one processor 814 operably coupled to the components of the control system 812. In some examples, the control system 812 may include a communication module providing for communication and exchange of information between the wearable device 800 and other external devices. In some examples, the head mounted wearable device 800 includes a gaze tracking device 815 to detect and track eye gaze direction and movement. Data captured by the gaze tracking device 815 may be processed to detect and track gaze direction and movement as a user input. In the example shown in FIGS. 8A and 8B, the gaze tracking device 815 is provided in one of two arm portions 830, simply for purposes of discussion and illustration. In the example arrangement shown in FIGS. 8A and 8B, the gaze tracking device 815 is provided in the same arm portion 830 as the display device 804, so that user eye gaze can be tracked not only with respect to objects in the physical environment, but also with respect to the content output for display by the display device 804. In some examples, gaze tracking devices 815 may be provided in each of the two arm portions 830 to provide for gaze tracking of each of the two eyes of the user. In some examples, display devices 804 may be provided in each of the two arm portions 830 to provide for binocular display of visual content.

The wearable device 800 is illustrated as glasses, such as smartglasses, augmented reality (AR) glasses, or virtual reality (VR) glasses. More generally, the wearable device 800 may represent any head-mounted device (HMD), including, e.g., goggles, helmet, or headband. Even more generally, the wearable device 800 and the computing device 706 may represent any wearable device(s), handheld computing device(s), or combinations thereof.

Use of the wearable device 800, and similar wearable or handheld devices such as those shown in FIG. 7, enables useful and convenient use case scenarios of implementations of FIGS. 1-6. For example, as shown in FIG. 8B, the display area 805 may be used to display the UI 106 of FIG. 1. More generally, the display area 805 may be used to provide any of the functionality described with respect to FIGS. 1-6 that may be useful in operating the head-based UI control manager 132.

Various implementations of the systems and techniques described here can be realized in digital electronic circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as modules, programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor, or LED (light emitting diode)) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback), and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the description and claims.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Further to the descriptions above, a user is provided with controls allowing the user to make an election as to both if and when systems, programs, devices, networks, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that user information is removed. For example, a user's identity may be treated so that no user information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

The computer system (e.g., computing device) may be configured to wirelessly communicate with a network server over a network via a communication link established with the network server using any known wireless communications technologies and protocols including radio frequency (RF), microwave frequency (MWF), and/or infrared frequency (IRF) wireless communications technologies and protocols adapted for communication over the network.

In accordance with aspects of the disclosure, implementations of various techniques described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that when executed cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

Specific structural and functional details disclosed herein are merely representative for purposes of describing example implementations. Example implementations, however, may be embodied in many alternate forms and should not be construed as limited to only the implementations set forth herein.

The terminology used herein is for the purpose of describing particular implementations only and is not intended to be limiting of the implementations. As used herein, the singular forms “a,” “an,” and “the” are intended to include the plural forms as well, unless the context clearly indicates otherwise. It will be further understood that the terms “comprises.” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled.” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 130 degrees or at other orientations) and the spatially relative descriptors used herein may be interpreted accordingly.

Example implementations of the concepts are described herein with reference to cross-sectional illustrations that are schematic illustrations of idealized implementations (and intermediate structures) of example implementations. As such, variations from the shapes of the illustrations as a result, for example, of manufacturing techniques and/or tolerances, are to be expected. Thus, example implementations of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example implementations.

It will be understood that although the terms “first.” “second,” etc. may be used herein to describe various elements, these elements should not be limited by these terms. These terms are only used to distinguish one element from another. Thus, a “first” element could be termed a “second” element without departing from the teachings of the present implementations.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

What is claimed is:

1. A non-transitory computer-readable medium storing executable instructions that when executed by at least one processor cause the at least one processor to:
receive at least one sensor signal from at least one motion sensor of a head-mounted device (HMD), the HMD associated with a user interface (UI) displaying a UI selection element;
determine a first value of the at least one sensor signal corresponding to a first position of the HMD;
determine a second value of the at least one sensor signal corresponding to a second position of the HMD;
determine an initialization point within the UI;
determine a relative displacement of the UI selection element, based on the initialization point, the first value, and the second value; and
move the UI selection element within the UI, based on the relative displacement.

2. The non-transitory computer-readable medium of claim 1, wherein the instructions, when executed by the at least one processor, are further configured to cause the at least one processor to:
process the first value and the second value using a machine learning model trained to relate sensor values of the at least one sensor signal to corresponding relative displacements of the UI selection element within the UI.

3. The non-transitory computer-readable medium of claim 1, wherein the instructions, when executed by the at least one processor, are further configured to cause the at least one processor to:
receive the at least one sensor signal from at least one motion sensor including receiving at least an x-direction signal, a y-direction signal, and a z-direction signal from at least one inertial measurement unit (IMU) of the HMD; and
determine the relative displacement based on the x-direction signal, the y-direction signal, and the z-direction signal.

4. The non-transitory computer-readable medium of claim 1, wherein the instructions, when executed by the at least one processor, are further configured to cause the at least one processor to:
determine that a variance in the at least one sensor signal exceeds a variance threshold; and
in response, expand at least one distance between a plurality of UI elements displayed in the UI.

5. The non-transitory computer-readable medium of claim 1, wherein the instructions, when executed by the at least one processor, are further configured to cause the at least one processor to:
determine an acceleration of the HMD in a direction of the relative displacement;
identify a UI element, based on the relative displacement and on the acceleration; and
pre-render a selection result of receiving a selection of the UI element by way of the UI selection element, prior to receiving the selection.

6. The non-transitory computer-readable medium of claim 1, wherein the instructions, when executed by the at least one processor, are further configured to cause the at least one processor to:
determine that a stability of the UI selection element with respect to a UI element exceeds a stability threshold; and
pre-render a selection result of receiving a selection of the UI element by way of the UI selection element, prior to receiving the selection.

7. The non-transitory computer-readable medium of claim 1, wherein the instructions, when executed by the at least one processor, are further configured to cause the at least one processor to:
determine the initialization point as a centroid of a plurality of UI elements of the UI.

8. The non-transitory computer-readable medium of claim 1, wherein the instructions, when executed by the at least one processor, are further configured to cause the at least one processor to:
buffer the at least one sensor signal over a first time window;
average first values of the at least one sensor signal over the first time window to a obtain an average sensor value; and
subtract the average sensor value from a sensor value detected in the first time window to obtain the first value.

9. The non-transitory computer-readable medium of claim 1, wherein the instructions, when executed by the at least one processor, are further configured to cause the at least one processor to:
relate the first value and the second value to the relative displacement using an adjustable sensitivity factor.

10. The non-transitory computer-readable medium of claim 1, wherein the HMD includes a pair of smartglasses, and the UI is generated by the smartglasses.

11. A head mounted device (HMD) comprising:
at least one frame;
at least one display displaying a user interface (UI) having a UI selection element;
at least one motion sensor;
at least one processor; and
at least one memory, the at least one memory storing a set of instructions, which, when executed, cause the at least one processor to:
receive at least one sensor signal from the at least one motion sensor;
determine a first value of the at least one sensor signal corresponding to a first position of the HMD;
determine a second value of the at least one sensor signal corresponding to a second position of the HMD;
determine an initialization point within the UI;
determine a relative displacement of the UI selection element, based on the initialization point, the first value, and the second value; and
move the UI selection element within the UI, based on the relative displacement.

12. The HMD of claim 11, wherein the set of instructions, when executed by the at least one processor, are further configured to cause the wearable device to:
process the first value and the second value using a machine learning model trained to relate sensor values of the at least one sensor signal to corresponding relative displacements of the UI selection element within the UI.

13. The HMD of claim 11, wherein the set of instructions, when executed by the at least one processor, are further configured to cause the wearable device to:
receive the at least one sensor signal from at least one motion sensor including receiving at least an x-direction signal, a y-direction signal, and a z-direction signal from at least one inertial measurement unit (IMU) of the HMD; and
determine the relative displacement based on the x-direction signal, the y-direction signal, and the z-direction signal.

14. The HMD of claim 11, wherein the set of instructions, when executed by the at least one processor, are further configured to cause the wearable device to:
determine that a variance in the at least one sensor signal exceeds a variance threshold; and
in response, expand at least one distance between a plurality of UI elements displayed in the UI.

15. The HMD of claim 11, wherein the set of instructions, when executed by the at least one processor, are further configured to cause the wearable device to:
determine an acceleration of the HMD in a direction of the relative displacement;
identify a UI element, based on the relative displacement and on the acceleration; and
pre-render a selection result of receiving a selection of the UI element by way of the UI selection element, prior to receiving the selection.

16. The HMD of claim 11, wherein the set of instructions, when executed by the at least one processor, are further configured to cause the wearable device to:
determine that a stability of the UI selection element with respect to a UI element exceeds a stability threshold; and
pre-render a selection result of receiving a selection of the UI element by way of the UI selection element, prior to receiving the selection.

17. A method comprising:
receiving at least one sensor signal from at least one motion sensor of a head-mounted device (HMD), the HMD associated with a user interface (UI) displaying a UI selection element;
determining a first value of the at least one sensor signal corresponding to a first position of the HMD;
determining a second value of the at least one sensor signal corresponding to a second position of the HMD;
determining an initialization point within the UI;
determining a relative displacement of the UI selection element, based on the initialization point, the first value, and the second value; and
moving the UI selection element within the UI, based on the relative displacement.

18. The method of claim 17, further comprising:
determining that a variance in the at least one sensor signal exceeds a variance threshold; and
in response, expanding at least one distance between a plurality of UI elements displayed in the UI.

19. The method of claim 17, further comprising:
determining an acceleration of the HMD in a direction of the relative displacement;
identifying a UI element, based on the relative displacement and on the acceleration; and
pre-rendering a selection result of receiving a selection of the UI element by way of the UI selection element, prior to receiving the selection.

20. The method of claim 17, further comprising:
determining that a stability of the UI selection element with respect to a UI element exceeds a stability threshold; and
pre-rendering a selection result of receiving a selection of the UI element by way of the UI selection element, prior to receiving the selection.
